(19) United States
(12) Patent Application Publication
(10) Pub. No.: US 2013/0066632 A1
(43) Pub. Date: Mar. 14, 2013

(54) SYSTEM AND METHOD FOR ENRICHING TEXT-TO-SPEECH SYNTHESIS WITH AUTOMATIC DIALOG ACT TAGS

(71) Applicants: Alistair D. Conkie, Morristown, NJ (US); Srinivas Bangalore, Morristown, NJ (US); Vivek Kumar Rangarajan Sridhar, Florham Park, NJ (US); Ann K. Syrdal, Morristown, NJ (US)

(72) Inventors: Alistair D. Conkie, Morristown, NJ (US); Srinivas Bangalore, Morristown, NJ (US); Vivek Kumar Rangarajan Sridhar, Florham Park, NJ (US); Ann K. Syrdal, Morristown, NJ (US)

(73) Assignee: AT&T Intellectual Property I, L.P., Atlanta, GA (US)

(21) Appl. No.: 13/232,630

(22) Filed: Sep. 14, 2011

(51) Int. Cl. G10L 13/08

(52) U.S. Cl. 704/260; 704/E13.011

(57) ABSTRACT

Disclosed herein are systems, methods, and non-transitory computer-readable storage media for modifying the prosody of synthesized speech based on an associated speech act. A system configured according to the method embodiment (1) receives text, (2) performs an analysis of the text to determine and assign a speech act label to the text, and (3) converts the text to speech, where the speech prosody is based on the speech act label. The analysis performed compares the text to a corpus of previously tagged utterances to find a close match, determines a confidence score from a correlation of the text and the close match, and, if the confidence score is above a threshold value, retrieving the speech act label of the close match and assigning it to the text.

### BACKGROUND

1. Technical Field

The present disclosure relates to spoken dialogue systems and more specifically to improving the synthetic speech generated by spoken dialogue systems.

2. Introduction

Industry has widely adopted spoken dialogue systems in place of or in conjunction with humans. For example, the high cost of training and employing humans may make relying solely on human operators impractical. One goal of such spoken dialog systems is to interact with humans in a sufficiently natural way that humans will accept and accomplish tasks via the spoken dialog systems. Spoken dialog systems generate responses to user input by choosing appropriate words and creating sentences out of words to generate text. Once the text of a response is determined, a synthesizer such as a text-to-speech synthesizer or unit-selection based text-to-speech module generates an audible response.

However, the response and its particular characteristics may not be appropriate or may not sound natural. As these systems continue to replace humans, they need to create a more natural dialogue, mimicking human intonations, accents, and mannerisms, that is both effective, understandable, and appropriate. Humans typically change linguistic characteristics while speaking depending on the type of speech as well as the form of dialogue. Some systems have implemented the ability to use a faux emotion in the synthesized voice; however, once again, this often leads to inappropriate simplification of the common human dialogue. Any improvements for synthesizing voices in spoken dialogue systems in order to create a more natural dialogue can lead to higher customer satisfaction and widespread acceptance of spoken dialog systems.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for modifying the prosody of synthesized speech based on an associated speech act. A system configured to practice the method (1) receives text, (2) analyzes the text to determine and assign a speech act label to the text, and (3) converts the text to speech, where the speech prosody is based on the speech act label. The analysis compares the text to a corpus of previously tagged utterances to find a close match, determines a confidence score from a correlation of the text and the close match, and, if the confidence score is above a threshold value, retrieving the speech act label of the close match and assigning it to the text. In this regard, features of the response, such as prosody and pitch, can be determined according to the assigned speech act. Thus, if the response is a question, yes/no answer, or any kind of particular speech act, the prosody and pitch of the speech can more accurately match human prosody and speech.

The principles disclosed herein can enhance a spoken dialogue system by generating an automated response that better reflects natural human dialogue. The system can change linguistic variables within the speech acts of the synthetic dialogue to more closely approximate natural human speech.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates a functional block diagram that illustrates an exemplary natural language spoken dialog system;

FIG. 3 illustrates a functional block diagram of an exemplary natural language spoken dialog system embodiment;

FIG. 4 illustrates a basic example of a catalogue used by the system;

FIG. 5 illustrates an alternate system architecture; and

FIG. 6 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

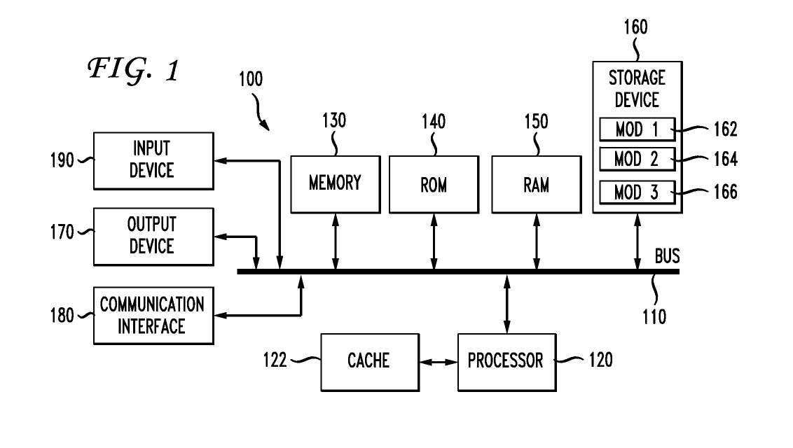

Spoken dialog systems aim to identify intents of humans, expressed in natural language, and take actions accordingly to satisfy human requests. The present disclosure addresses the need in the art for improved spoken dialog systems. A system, method and non-transitory computer-readable media are disclosed which convert text to speech and, based on previous utterances, assigns a dialog act to the text, which is used to vary prosody and pitch in the speech. A brief introductory description of a basic general purpose system or computing device in FIG. 1 which can be employed to practice the concepts is disclosed herein. A more detailed description and various embodiments will then follow accompanying the remaining figures. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

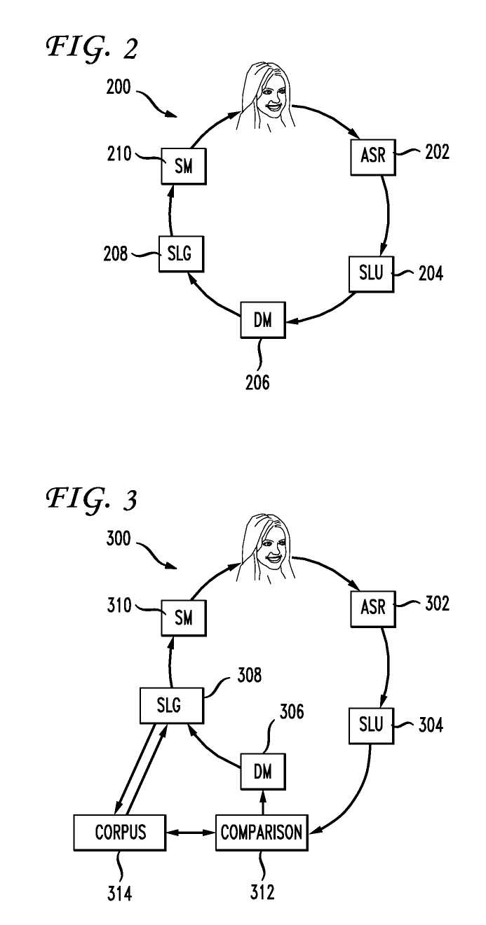

Having disclosed some components of a computing system, the disclosure now turns to FIG. 2, which illustrates an exemplary natural language spoken dialog system. FIG. 2 is a functional block diagram that illustrates an exemplary natural language spoken dialog system. Spoken dialog systems aim to identify intents of humans, expressed in natural language, and take actions accordingly, to satisfy their requests. Natural language spoken dialog system 200 can include an automatic speech recognition (ASR) module 202, a spoken language understanding (SLU) module 204, a dialog management (DM) module 206, a spoken language generation (SLG) module 208, and synthesizing module 210. The synthesizing module can be any type of speech output module. For example, it can be a module wherein one prerecorded speech segment is selected and played to a user. Thus, the synthesizing module represents any type of speech output. The present disclosure focuses on innovations related to the ASR module 202 and can also relate to other components of the dialog system.

The automatic speech recognition module 202 analyzes speech input and provides a textual transcription of the speech input as output. SLU module 204 can receive the transcribed input and can use a natural language understanding model to analyze the group of words that are included in the transcribed input to derive a meaning from the input. The role of the DM module 206 is to interact in a natural way and help the user to achieve the task that the system is designed to support. The DM module 206 receives the meaning of the speech input from the SLU module 204 and determines an action, such as, for example, providing a response, based on the input. The SLG module 208 generates a transcription of one or more words in response to the action provided by the DM 206. The synthesizing module 210 receives the transcription as input and provides generated audible speech as output based on the transcribed speech.

Thus, the modules of system 200 recognize speech input, such as speech utterances, transcribe the speech input, identify (or understand) the meaning of the transcribed speech, determine an appropriate response to the speech input, generate text of the appropriate response and from that text, generate audible “speech” from system 200, which the user then hears. In this manner, the user can carry on a natural language dialog with system 200. Those of ordinary skill in the art will understand the programming languages for generating and training automatic speech recognition module 202 or any of the other modules in the spoken dialog system. Further, the modules of system 200 can operate independent of a full dialog system. For example, a computing device such as a smartphone (or any processing device having a phone capability) can include an ASR module wherein a user says “call mom” and the smartphone acts on the instruction without a “spoken dialog.” A module for automatically transcribing user speech can join the system at any point or at multiple points in the cycle or can be integrated with any of the modules shown in FIG. 2.

Having described both a sample computing system and an exemplary natural language spoken dialog system, the disclosure now turns to FIG. 3 which illustrates a functional block diagram of an exemplary natural language spoken dialog system embodiment 300 which is a modification of the system shown in FIG. 2. While FIG. 3 shows one possible arrangement, other arrangements can be used which modify the system of FIG. 2 differently, such as by modifying or extending the functionality of existing components. Some configurations do not rely on the system of FIG. 2. In this embodiment, the ASR 302, SLU 304, DM 306, SLG 308, and SM 310 modules are present and largely perform the same functions as defined in FIG. 2. However, the SLU module 304, upon identifying the meaning of the received speech after the ASR 302 converts the received speech to text, does not forward the speech meaning directly to the DM 306. Rather, the SLU 304 forwards the speech meaning to a comparison module 312. In an alternate arrangement, SLU 304 passes its output to both DM 306 and comparison module 312, which process the output in parallel.

The comparison module 312 uses the meaning of the received speech to determine and assign a dialog act for the received speech. The comparison module 312 first compares the text received from the ASR 302 by way of the SLU 304 against the corpus 314 to find a similar utterance within the corpus 314. Comparison module 312 compares the speech meaning received from the SLU 304 to the dialog act of the similar utterance and determines a confidence score indicating a similarity between the speech meaning and the dialog act. The confidence score relates the proximity of the received speech to the similar utterance. If the confidence score is above a threshold value, the same dialog act assigned to the similar utterance will be assigned to the received speech. While the illustrated embodiment 300 shows the comparison module 312 as a separate module, in certain embodiments this comparison and assignment of a dialog act to the received speech can occur in the SLU 304, for example.

Upon identifying the dialog act of the received speech the comparison module 312 forwards the results to the DM 306 and determines an action, such as providing a response based on that input. The response produced by the DM 306 is often in a text form, and is assigned a dialog act based on the dialog act of the input. For example, if the input has a dialog act of a question, the response could have a dialog act of general information. Alternatively, the system 300 can recognize that the received speech is a question, but further determine that, based on the question, the user has at least one additional question. For example, if a speech dialog system receives the speech “Do you have good hamburgers?”, the system can assign a dialog tag of Question to this speech. Possible responses to this question could be “Yes, we have 15 excellent and distinct types of hamburgers” or “What would make a good hamburger?” These possible responses can be associated with dialog act tags of General Information and Question, respectively. The DM 306 can assign a dialog act to the response without consulting the corpus, however DM 306 can consult the corpus 314 to ensure that the dialog act assigned to the response correctly matches the intended tone and message determined by the DM 306.

Upon the DM 306 determining a response, the text of the response is forwarded to the SLG module 308, which synthesizes the text of the response into speech output. To provide a more natural dialog, and ensure that the response has the right prosody the SLG 308 searches the corpus 314 for similar dialog act labels to that assigned to the response. Prosody of speech can describe tone, intonation, rhythm, focus, syllable length, loudness, pitch, formant, or lexical stress, for example. Based on this search, the SLG 308 can determine patterns of prosody for the type of dialog act label assigned to the response text, and can form an output with corresponding prosody. In this manner, the speech output by the speech module (SM) 310 has an improved prosody that more closely resembles human speech.

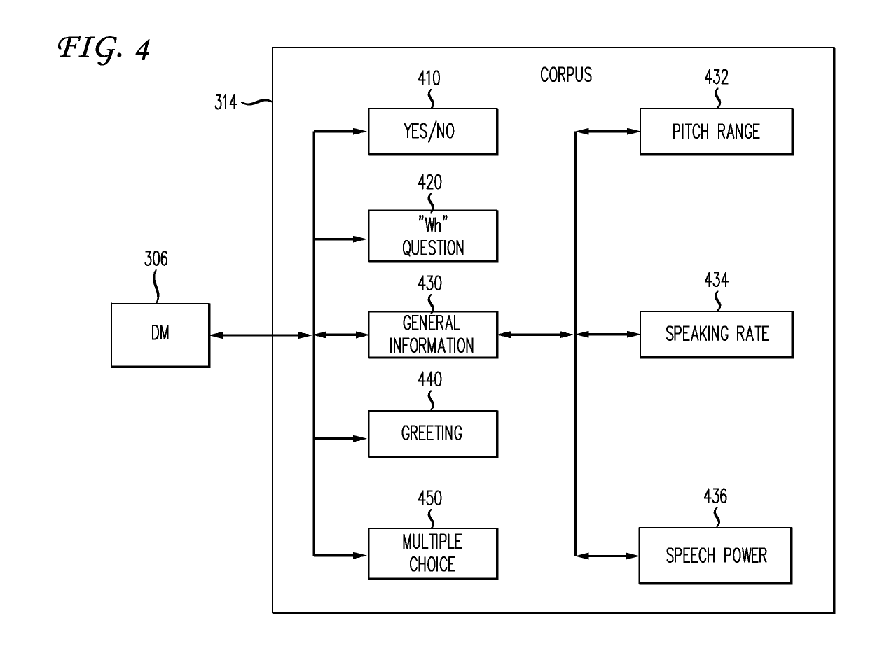

FIG. 4 represents one embodiment of the catalogue which demonstrates some of the speech acts available to the system 100 and some of the respective linguistic variables that the system can change depending on the specified speech act. In FIG. 4, the DM module 306 accesses the corpus 314 because a general information speech act is going to be generated by the system 100. When the system 100 generates the general information speech act 430, its linguistic variables are chosen based on how the corpus is populated. This embodiment of the system is going to produce a synthetic response with the pitch range 432, the speaking rate 434, and the speech power 436 associated with a general information speech act 430 as shown. The DM module 306 then communicates the appropriate linguistic variables to the SLG module 308 which produces the appropriate text that the synthesizer 310 uses to generate the synthesized response. In other embodiments, the number of speech act labels can number more or less than those shown.

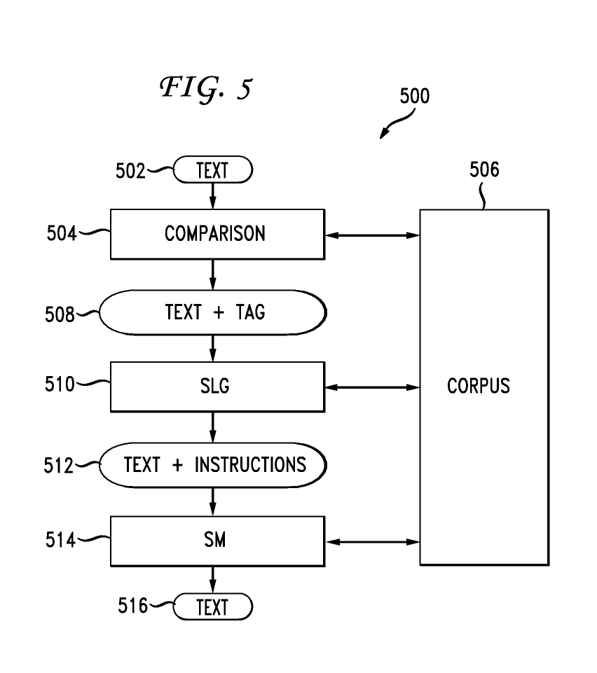

FIG. 5 illustrates an alternate system architecture 500. In this architecture 500, incoming text 502 is compared 504 to a corpus 506 to generate texts+tags 508. The text+tags 508 are passed to SLG 510 which uses the text+tags 508 in coordination with information fetched from the corpus 506 to generate text+instructions 512 for generating speech. SM 514 receives and processes the text+instructions 512 and generates output speech 516. This architecture, for example, is not necessarily part of a spoken dialog system as shown in FIGS. 2 and 3. These applications can be part of or provide support for a speech synthesis system. While the examples discussed herein are directed to speech, the same principles for modifying audio variables can be applied to non-speech, such as grunting, humming, sighing, and other non-speech but potentially communicative human noises.

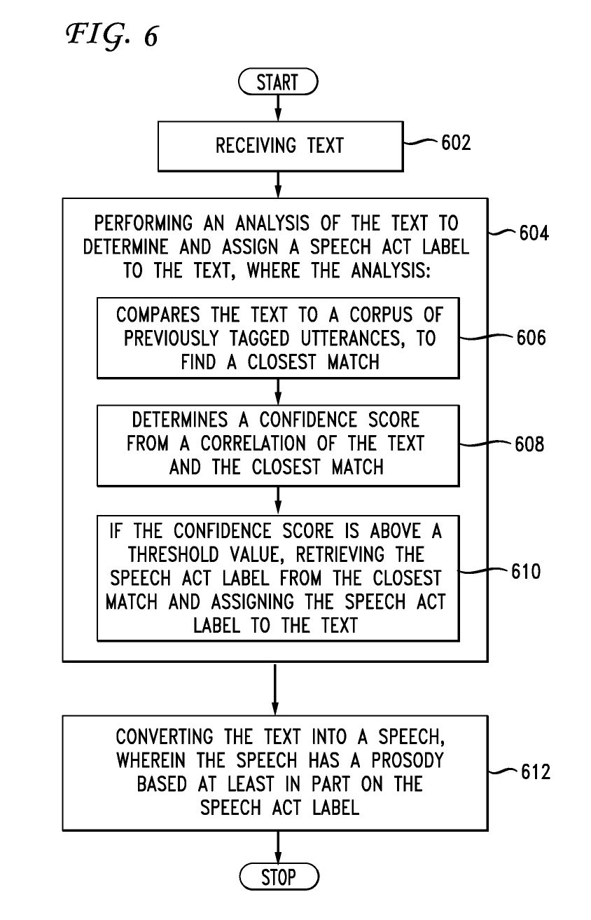

Having disclosed some basic system components and concepts, the disclosure now turns to the exemplary method embodiment shown in FIG. 6. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps.

The system 100 receives text (602) intended to be synthesized into speech output as a response, an interruption, a prompt, or any other form of speech. The text enters a comparison module which performs an analysis of the text to determine and assign a speech act label to the text (604). This analysis (604) compares the text to similar utterances stored within a corpus (606). Upon comparing the utterances found, the system 100 takes the closest match and determines a confidence score from a correlation of the text and the closest match (608). If the closest match is sufficiently similar to the text, the system 100 applies the same speech act label to the text as is on the closest match (610). To determine if the text and closest match are sufficiently similar, the system 100 compares the confidence score against a threshold requirement. Upon completing the analysis, the system 100 converts the text into a speech, where the speech has a prosody based at least in part on the speech act label (612).

In certain embodiments having additional speech act labels for example, multiple speech act labels can be assigned to a singular text. In one example, if a human interacting with the system 100 seems to be having trouble understanding the speech, the system applies both a General Information speech act label and a Slow speech act label. In another aspect, the system 100 can change or modify the speech act labels that are assigned to a text depending on a specific situation. For instance, if the system 100 needs to repeat a speech output multiple times, it can be helpful to vary the prosody between iterations, which can occur by modifying the speech act label or labels assigned to the text. Similarly, if an accent or dialect is detected, the system 100 can add a speech act label reflecting that accent, modifying the prosody to match. These accent specific speech act labels can have varying levels, could be introduced only after it becomes apparent that the user does not understand the prompts, or could be based on the known geography of the user.

In another aspect, assigning text one or more speech act labels in a speech dialog system can occur within a pre-existing module, such as the dialog management module, or can occur within a separate module. Likewise, the corpus can be contained within pre-existing data storage structures, including pre-existing modules, or can exist autonomously as a separate module. In yet another aspect, the threshold for determining if a confidence score is can be predetermined by the system 100, or can be preset by a user. When the threshold is preset by a user, this preset can be specific to the circumstances the system 100 is being used in, or can be a generic preset.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply both to speech dialog systems and speech systems where a dialog between the system and a human does not occur, however the system does convey speech to the human requiring varying prosody. Those skilled in the art will readily recognize various modifications and changes that may be made to the principles described herein without following the example embodiments and applications illustrated and described herein, and without departing from the spirit and scope of the disclosure.

We claim:

1. A method comprising:
receiving text;
analyzing, via a processor, the text to determine and assign a speech act label to the text, wherein analyzing comprises:
comparing the text to a corpus of previously labeled utterances to find a closest match;
determining a confidence score from a correlation of the text and the closest match; and
if the confidence score is above a threshold value, retrieving the speech act label from the closest match and assigning the speech act label to the text; and
converting the text to speech, wherein the speech has a prosody based at least in part on the speech act label.

2. The method of claim 1, wherein the text is assigned a plurality of speech act labels.

3. The method of claim 1, wherein analyzing occurs within a dialog management module.

4. The method of claim 1, wherein analyzing further comprises:
assigning additional speech labels based on at least one of dialect, accent, message repetition, and text theme.

5. The method of claim 1, wherein the prosody describes at least one of tone, intonation, rhythm, focus, syllable length, loudness, pitch, formant, and lexical stress.

6. The method of claim 1, wherein the prosody matches a stored prosody found in the corpus.

7. The method of claim 1, further comprising:
outputting the speech to a user.

8. A system comprising:
a processor; and
a storage device storing instructions for controlling the processor to perform steps comprising:
receiving text;
analyzing the text to determine and assign a speech act label to the text, wherein analyzing comprises:
comparing the text to a corpus of previously labeled utterances to find a closest match;
determining a confidence score from a correlation of the text and the closest match; and
if the confidence score is above a threshold value, retrieving the speech act label from the closest match and assigning the speech act label to the text; and
converting the text to speech, wherein the speech has a prosody based at least in part on the speech act label.

9. The system of claim 8, wherein the text is assigned a plurality of speech act labels.

10. The system of claim 8, wherein analyzing occurs within a dialog management module.

11. The system of claim 8, analyzing further comprises:
assigning additional speech labels based on at least one of dialect, accent, message repetition, and text theme.

12. The system of claim 8, wherein the prosody describes at least one of tone, intonation, rhythm, focus, syllable length, loudness, pitch, formant, and lexical stress.

13. The system of claim 8, wherein the prosody matches a stored prosody found in the corpus.

14. The system of claim 8, further comprising:
outputting the speech to a user.

15. A non-transitory computer-readable storage medium storing instructions which, when executed by a computing device, cause the computing device to perform steps comprising:
receiving text;
analyzing the text to determine and assign a speech act label to the text, wherein analyzing comprises:
comparing the text to a corpus of previously labeled utterances to find a closest match;
determining a confidence score from a correlation of the text and the closest match; and
if the confidence score is above a threshold value, retrieving the speech act label from the closest match and assigning the speech act label to the text; and
converting the text to speech, wherein the speech has a prosody based at least in part on the speech act label.

16. The non-transitory computer-readable storage medium of claim 15, wherein the text is assigned a plurality of speech act labels.

17. The non-transitory computer-readable storage medium of claim 15, wherein analyzing occurs within a dialog management module.

18. The non-transitory computer-readable storage medium of claim 15, wherein analyzing further comprises:
assigning additional speech labels based on at least one of dialect, accent, message repetition, and text theme.

19. The non-transitory computer-readable storage medium of claim 15, wherein the prosody describes at least one of tone, intonation, rhythm, focus, syllable length, loudness, pitch, formant, and lexical stress.

20. The non-transitory computer-readable storage medium of claim 15, wherein the prosody matches a stored prosody found in the corpus.
